(19) United States
(12) Patent Application Publication
(10) Pub. No.: US 2026/0276390 A1
(43) Pub. Date: Sep. 17, 2026

(54) ROUTE SETTING METHOD, COMPUTER PROGRAM, AND MOBILE OBJECT

(71) Applicant: MITSUBISHI HEAVY INDUSTRIES, LTD., Tokyo (JP)

(72) Inventors: Hirotaka OKAZAKI, Tokyo (JP); Kenji TAKAO, Tokyo (JP)

(73) Assignee: MITSUBISHI HEAVY INDUSTRIES, LTD., Tokyo (JP)

(21) Appl. No.: 19/099,363

(22) PCT Filed: Sep. 21, 2023
(86) PCT No.: PCT/JP2023/034224

§ 371 Date: Nov. 5, 2025

(30) Foreign Application Priority Data
Sep. 26, 2022 (JP) 2022-152754

(51) Int. Cl. G01C 21/20

(52) U.S. Cl. CPC G01C 21/206

(57) ABSTRACT

To appropriately set a route for turning. A route setting method includes a step of setting a route for a mobile object. At the step of setting the route, in a case in which a first route passing through positions within a predetermined distance from a first way point and positions within a predetermined distance from a second way point cannot be set, a third way point at the same position as the first way point or a position more distant from a second path than the first way point, and a fourth way point at the same position as the second way point or a position more distant from a first path than the second way point are set so that a distance from the third way point to the fourth way point is longer than a distance from the first way point to the second way point, and a route passing through positions within a predetermined distance from the third way point and positions within the predetermined distance from the fourth way point is set as the route for the mobile object.

### FIELD

The present disclosure relates to a route setting method, a computer program, and a mobile object.

### BACKGROUND

There is known a technique of setting a moving route for a mobile object. For example, Patent Literature 1 describes that a route from a starting point to an ending point is set to avoid a prohibition region.

### CITATION LIST

### Patent Literature

Patent Literature 1: Japanese Patent Application Laid-open No. 2008-129695

### SUMMARY

### Technical Problem

Here, the mobile object moves along a route for turning in some cases, and there is a demand for appropriately setting such a route for turning.

The present disclosure solves the problem described above, and aims at providing a route setting method, a computer program, and a mobile object with which a route for turning can be appropriately set.

### Solution to Problem

The route setting method of the present disclosure comprises: a step of acquiring information about way points through which a mobile object is expected to pass; and a step of setting a route for the mobile object based on the way points, wherein, at the step of setting the route, in a case in which a path connecting the way points includes a first path and a second path intersecting with the first path, and the way point closest to the second path on the first path is assumed to be a first way point and the way point closest to the first path on the second path is assumed to be a second way point, when a first route passing through positions within a predetermined distance from the first way point and positions within the predetermined distance from the second way point is unable to be set, a third way point at the same position as the first way point or a position more distant from the second path than the first way point and a fourth way point at the same position as the second way point or a position more distant from the first path than the second way point are set so that a distance from the third way point to the fourth way point is longer than a distance from the first way point to the second way point, and a route passing through positions within the predetermined distance from the third way point and positions within the predetermined distance from the fourth way point is set as the route for the mobile object.

The computer program of the present disclosure causes a computer to execute: a step of acquiring information about way points through which a mobile object is expected to pass; and a step of setting a route for the mobile object based on the way points, wherein, at the step of setting the route for the mobile object, in a case in which a path connecting the way points includes a first path and a second path intersecting with the first path, and the way point closest to the second path on the first path is assumed to be a first way point and the way point closest to the first path on the second path is assumed to be a second way point, when a first route passing through positions within a predetermined distance from the first way point and positions within the predetermined distance from the second way point is unable to be set, a third way point at the same position as the first way point or a position more distant from the second path than the first way point and a fourth way point at the same position as the second way point or a position more distant from the first path than the second way point are set so that a distance from the third way point to the fourth way point is longer than a distance from the first way point to the second way point, and a route passing through positions within the predetermined distance from the third way point and positions within the predetermined distance from the fourth way point is set as the route for the mobile object.

The mobile object of the present disclosure is configured to move along a route that is set based on information about way points through which the mobile object is expected to pass, wherein in a case in which a path connecting the way points include a first path and a second path intersecting with the first path, and the way point closest to the second path on the first path is assumed to be a first way point and the way point closest to the first path on the second path is assumed to be a second way point, when a first route passing through positions within a predetermined distance from the first way point and positions within the predetermined distance from the second way point is unable to be set, the route is set to pass through positions within a predetermined distance from a third way point and positions within a predetermined distance from a fourth way point, and the third way point is present at the same position as the first way point or a position more distant from the second path than the first way point, the fourth way point is present at the same position as the second way point or a position more distant from the first path than the second way point, and a distance from the third way point to the fourth way point is longer than a distance from the first way point to the second way point.

### Advantageous Effects of Invention

According to the present disclosure, a route for turning can be appropriately set.

### BRIEF DESCRIPTION OF DRAWINGS

FIG. 1 is a schematic diagram of a movement control system according to an embodiment.

FIG. 2 is a schematic diagram of a configuration of a mobile object.

FIG. 3 is a schematic block diagram of a management device.

FIG. 4 is a schematic block diagram of an information processing device.

FIG. 5 is a schematic block diagram of a control device for the mobile object.

FIG. 6 is a schematic diagram illustrating an example of way points through which the mobile object is expected to pass.

FIG. 7 is a schematic diagram illustrating an example of setting of a route for turning.

FIG. 8 is a schematic diagram illustrating an example of setting of a route for turning.

FIG. 9 is a schematic diagram illustrating another example of setting of a route for turning.

FIG. 10 is a schematic diagram for explaining an example of a setting method for way points.

FIG. 11A is a flowchart for explaining a processing flow of setting of a route according to the present embodiment.

FIG. 11B is a schematic diagram illustrating another example of setting of a route for turning.

FIG. 12 is a schematic diagram for explaining setting of a prohibition region.

FIG. 13 is a schematic diagram for explaining setting of a prohibition region.

### DESCRIPTION OF EMBODIMENTS

The following describes preferred embodiments of the present disclosure in detail with reference to the attached drawings. It should be noted that the present disclosure is not limited to the embodiments, and encompasses a combination of embodiments in a case in which there are a plurality of embodiments.

### First Embodiment

### (Movement Control System)

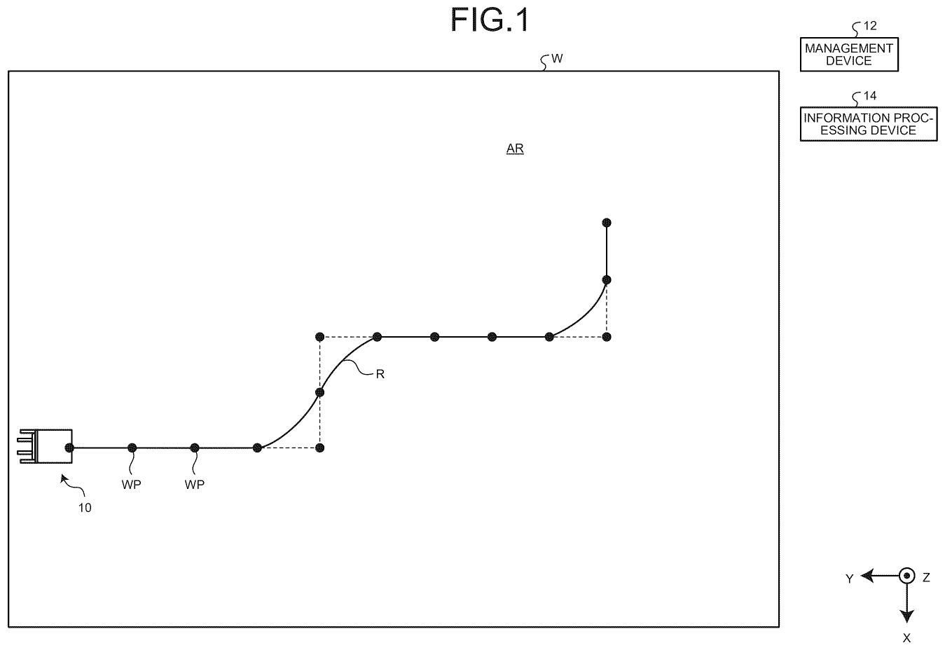

FIG. 1 is a schematic diagram of a movement control system according to the present embodiment. As illustrated in FIG. 1, a movement control system 1 according to the present embodiment includes a mobile object 10, a management device 12, and an information processing device 14. The movement control system 1 is a system that controls movement of the mobile object 10 belonging to a facility W. The facility W is a facility in which physical distribution is managed such as a warehouse, for example, but may be an optional facility in which the mobile object 10 is operated. In the movement control system 1, the mobile object 10 picks up and conveys a target object disposed in a region AR of the facility W. The region AR is, for example, a floor surface of the facility W, and is a region in which the target object is disposed or the mobile object 10 moves. In the present embodiment, the target object conveyed by the mobile object 10 is an object to be conveyed in which cargo is loaded on a palette. However, the target object is not limited to a palette on which cargo is loaded, but may be in any form. For example, the target object may be only cargo without a palette. Moreover, the mobile object 10 is not limited to the mobile object that conveys the target object, but may be a device that moves in the facility W for an optional purpose.

Hereinafter, a direction along the region AR is assumed to be an X-direction, and a direction running along the region AR and intersecting with the X-direction is assumed to be a Y-direction. In the present embodiment, the Y-direction is a direction orthogonal to the X-direction. It can be said that the X-direction and the Y-direction are directions along a horizontal plane. Moreover, a direction orthogonal to the X-direction and the Y-direction, more specifically, a direction toward an upper side in a vertical direction, is assumed to be a Z-direction. Moreover, in the present embodiment, unless otherwise specified, a “position” indicates a position (coordinates) in a coordinate system on a two-dimensional surface on the region AR (coordinate system of the region AR). Moreover, an “attitude” of the mobile object 10 and the like indicates orientation of the mobile object 10 and the like in the coordinate system of the region AR unless otherwise specified, and indicates a yaw angle (rotation angle) of the mobile object 10 when viewed from the Z-direction assuming that the X-direction is 0°.

### (Mobile Object)

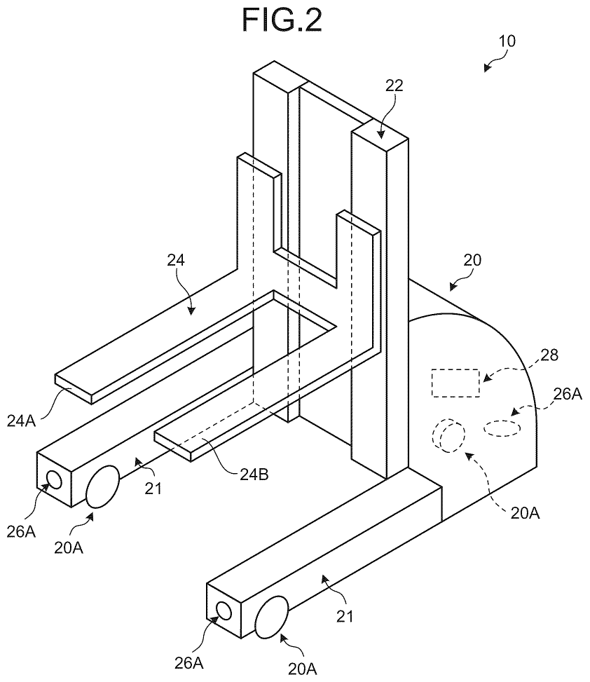

FIG. 2 is a schematic diagram of a configuration of the mobile object. The mobile object 10 is a device that can automatically move. In the present embodiment, the mobile object 10 is a nonholonomic system that cannot laterally move. In the present embodiment, the mobile object 10 is a device that can convey the target object. In more detail, in the present embodiment, the mobile object 10 is a forklift, and more specifically, the mobile object 10 is what is called an Automated Guided Vehicle (AGV) or an Automated Guided Forklift (AGF). However, the mobile object 10 is not limited to the forklift that conveys the target object, but may be an optional device that can automatically move.

As illustrated in FIG. 2, the mobile object 10 includes a vehicle body 20, wheels 20A, straddle legs 21, a mast 22, a fork 24, sensors 26A, and a control device 28. The straddle legs 21 are a pair of shaft-like members disposed at one end part in a front and rear direction of the vehicle body 20 to project from the vehicle body 20. The wheels 20A are disposed at front ends of the respective straddle legs 21 and on the vehicle body 20. That is, the three wheels 20A are disposed in total, but positions and the number of the wheels 20A may be optional. The mast 22 is attached to the straddle legs 21 to be movable, and moves in the front and rear direction of the vehicle body 20. The mast 22 extends along an upper and lower direction (herein, the Z-direction) orthogonal to the front and rear direction. The fork 24 is attached to the mast 22 to be movable in the Z-direction. The fork 24 may be attached to the mast 22 to be movable also in a lateral direction (direction intersecting with the upper and lower direction and the front and rear direction) of the vehicle body 20. The fork 24 includes a pair of hooks 24A and 24B. The hooks 24A and 24B extend from the mast 22 toward a front direction of the vehicle body 20. The hooks 24A and 24B are disposed to be separated from each other in the lateral direction of the mast 22. Hereinafter, of the front and rear direction of the mobile object 10, a direction on a side where the fork 24 is disposed is assumed to be a front direction, and a direction on a side where the fork 24 is not disposed is assumed to be a rear direction.

The sensor 26A detects at least one of a position and an attitude of an object present around the vehicle body 20. It can also be said that the sensor 26A detects at least one of the position of the object with respect to the mobile object 10 and the attitude of the object with respect to the mobile object 10. In the present embodiment, the sensors 26A are disposed at the front ends in the front direction of the respective straddle legs 21, and on a backward side of the vehicle body 20. However, the positions where the sensors 26A are disposed are not limited thereto. The sensors 26A may be disposed at optional positions, and the number of the sensors 26A to be disposed may be optional.

The sensor 26A is a sensor that emits laser light, for example. The sensor 26A emits laser light while performing scanning in one direction (herein, the lateral direction), and detects the position and orientation of the object based on reflected light of the emitted laser light. That is, it can be said that the sensor 26A is what is called two-dimensional (2D)-Light Detection And Ranging (LiDAR). However, the sensor 26A is not limited thereto, but may be a sensor that detects the object using an optional method. For example, the sensor 26A may be what is called three-dimensional (3D)-LiDAR that performs scanning in a plurality of directions, what is called one-dimensional (1D)-LiDAR that does not perform scanning, or a camera.

The control device 28 controls movement of the mobile object 10. The control device 28 will be described later.

### (Management Device)

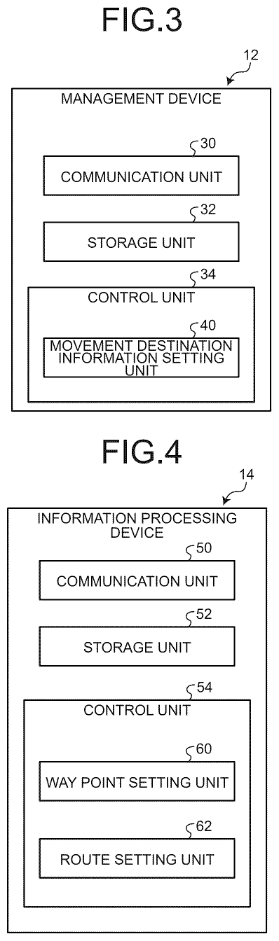

FIG. 3 is a schematic block diagram of a management device. The management device 12 is a system that manages physical distribution in the facility W. The management device 12 is a Warehouse Control System (WCS) or a Warehouse Management System (WMS) in the present embodiment, but may be an optional system other than the WCS and the WMS. For example, the management device 12 may be a back-end system such as another production management system. A position where the management device 12 is disposed is optional. The management device 12 may be disposed in the facility W, or disposed at a position distant from the facility W to manage the facility W from the distant position. The management device 12 is a computer, and includes a communication unit 30, a storage unit 32, and a control unit 34 as illustrated in FIG. 3.

The communication unit 30 is a module used by the control unit 34 to communicate with an external device such as the information processing device 14, and may include an antenna, for example. A communication scheme used by the communication unit 30 is wireless communication in the present embodiment, but the communication scheme may be optional. The storage unit 32 is a memory that stores various kinds of information such as a computer program or arithmetic content of the control unit 34, and includes, for example, at least one of a main storage device such as a random access memory (RAM) or a read only memory (ROM), and an external storage device such as a hard disk drive (HDD).

The control unit 34 is an arithmetic device, and includes an arithmetic circuit such as a central processing unit (CPU), for example. The control unit 34 includes a movement destination information setting unit 40. The control unit 34 reads out, from the storage unit 32, and executes a computer program (software) to implement the movement destination information setting unit 40, and performs processing thereof. It should be noted that the control unit 34 may perform processing by one CPU, or may include a plurality of CPUs and perform processing by the CPUs. Moreover, the movement destination information setting unit 40 may also be implemented by a hardware circuit. Moreover, a computer program for the control unit 34 stored in the storage unit 32 may be stored in a recording medium that can be read by the management device 12.

The movement destination information setting unit 40 sets movement destination information indicating a movement destination of the mobile object 10. Setting of the movement destination information will be described later.

It should be noted that the management device 12 may also perform processing other than the setting of the movement destination information. For example, the management device 12 may also set information for controlling a mechanism (for example, an elevator or a door) other than the mobile object 10 disposed in the facility W.

### (Information Processing Device)

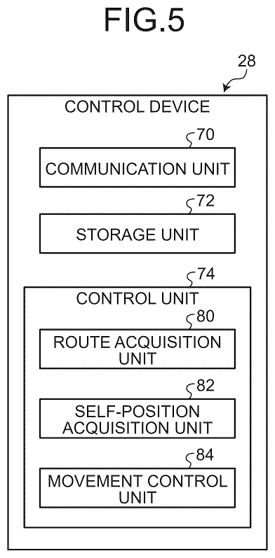

FIG. 4 is a schematic block diagram of the information processing device. The information processing device 14 is a device disposed in the facility W to process information and the like about movement of the mobile object 10. The information processing device 14 is, for example, a Fleet Control System (FCS), but is not limited thereto. The information processing device 14 may be an optional device that processes information about movement of the mobile object 10. The information processing device 14 is a computer, and includes a communication unit 50, a storage unit 52, and a control unit 54 as illustrated in FIG. 4. The communication unit 50 is a module used by the control unit 54 to communicate with an external device such as the management device 12 or the mobile object 10, and may include an antenna, for example. A communication scheme used by the communication unit 50 is wireless communication in the present embodiment, but the communication scheme may be optional. The storage unit 52 is a memory that stores various kinds of information such as a computer program or arithmetic content of the control unit 54, and includes, for example, at least one of a main storage device such as a RAM and a ROM, and an external storage device such as an HDD.

The control unit 54 is an arithmetic device, and includes an arithmetic circuit such as a CPU, for example. The control unit 54 includes a way point setting unit 60 and a route setting unit 62. The control unit 54 reads out, from the storage unit 52, and executes a computer program (software) to implement the way point setting unit 60 and the route setting unit 62, and performs processing thereof. It should be noted that the control unit 54 may perform the processing thereof by one CPU, or may include a plurality of CPUs and perform the processing by the CPUs. Moreover, at least part of the way point setting unit 60 and the route setting unit 62 may be implemented by a hardware circuit. Moreover, a computer program for the control unit 54 stored in the storage unit 52 may be stored in a recording medium that can be read by the information processing device 14.

The way point setting unit 60 sets way points WP through which the mobile object 10 is expected to pass. The way point WP is a point set in advance for each position (coordinates) in the region AR. The way points WP are set in accordance with a layout of the facility W. The way point setting unit 60 sets the way points WP through which the mobile object 10 is expected to pass among the way points WP set in advance. Moreover, the route setting unit 62 sets a route R along which the mobile object 10 moves based on the set way points WP. A setting method for the way points WP and the route R will be described later.

It should be noted that in the present embodiment, the management device 12 and the information processing device 14 are separate devices, but may be an integrated device. That is, the management device 12 may have at least part of the function of the information processing device 14, or the information processing device 14 may have at least part of the function of the management device 12.

### (Control Device for Mobile Object)

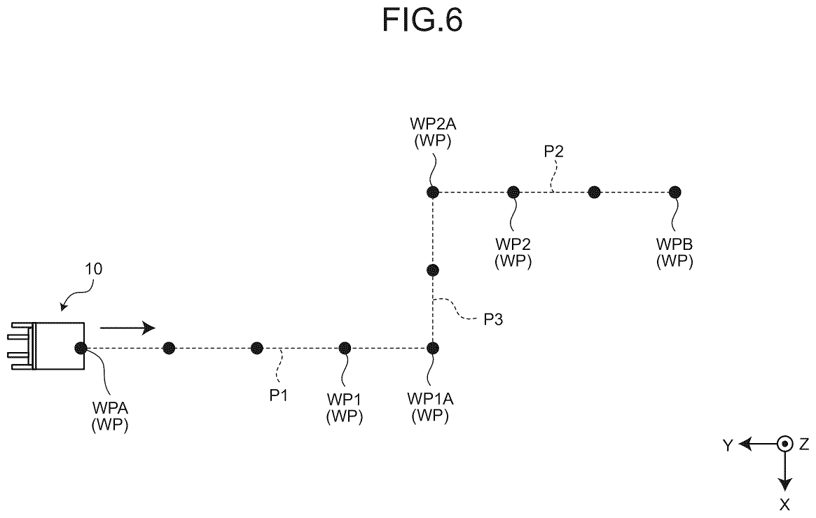

Next, the following describes the control device 28 for the mobile object 10. FIG. 5 is a schematic block diagram of the control device for the mobile object. The control device 28 is a device that controls the mobile object 10. The control device 28 is a computer, and includes a communication unit 70, a storage unit 72, and a control unit 74 as illustrated in FIG. 5. The communication unit 70 is a module used by the control unit 74 to communicate with an external device such as the information processing device 14, and may include an antenna, for example. A communication scheme used by the communication unit 70 is wireless communication in the present embodiment, but the communication scheme may be optional. The storage unit 72 is a memory that stores various kinds of information such as a computer program or arithmetic content of the control unit 74, and includes, for example, at least one of a main storage device such as a RAM and a ROM, and an external storage device such as an HDD.

The control unit 74 is an arithmetic device, and includes an arithmetic circuit such as a CPU, for example. The control unit 74 includes a route acquisition unit 80, a self-position acquisition unit 82, and a movement control unit 84. The control unit 74 reads out, from the storage unit 72, and executes a computer program (software) to implement the route acquisition unit 80, the self-position acquisition unit 82, and the movement control unit 84, and performs processing thereof. It should be noted that the control unit 74 may perform the processing thereof by one CPU, or may include a plurality of CPUs and perform the processing by the CPUs. Moreover, at least part of the route acquisition unit 80, the self-position acquisition unit 82, and the movement control unit 84 may be implemented by a hardware circuit. Moreover, computer program for the control unit 74 stored in the storage unit 72 may be stored in a recording medium that can be read by the control device 28.

The route acquisition unit 80 acquires information about the route R. The self-position acquisition unit 82 acquires position information about the mobile object 10. The movement control unit 84 controls a moving mechanism such as a driving unit or a steering wheel of the mobile object 10 to control movement of the mobile object 10. Specific processing content thereof will be described later.

### (Processing of Movement Control System)

The following describes processing content of the movement control system 1.

### (Setting of Movement Destination Information)

The movement destination information setting unit 40 of the management device 12 sets movement destination information indicating a movement destination of the mobile object 10. The movement destination information setting unit 40 may designate a position (coordinates) of the movement destination itself as the movement destination information. Moreover, an identifier is given to each of the way points WP, and the movement destination information setting unit 40 may designate the identifier of the way point WP corresponding to the movement destination as the movement destination information. The movement destination information setting unit 40 may set the movement destination information using an optional method. For example, the movement destination information setting unit 40 may acquire order information indicating a target object to be conveyed, a conveyance source, and a conveyance destination to set the movement destination information based thereon. The movement destination information setting unit 40 transmits the set movement destination information to the information processing device 14 via the communication unit 30.

### (Setting of Way Points)

The way point setting unit 60 of the information processing device 14 acquires information about the way points WP through which the mobile object 10 is expected to pass. The way point setting unit 60 may acquire the information about the way points WP using an optional method. For example, the way point setting unit 60 may acquire the information about the way points WP from another device such as the management device 12, but in the present embodiment, the way point setting unit 60 sets the way points WP by itself. In the present embodiment, the way point setting unit 60 sets the way points WP through which the mobile object 10 is expected to pass based on the movement destination information. The way point setting unit 60 sets, as the way points WP through which the mobile object 10 is expected to pass, the way point WP of the movement source (departure point), the way point WP of the movement destination (arrival point), and the way point WP connecting the way point WP of the movement source and the way point WP of the movement destination. The way point WP of the movement source may be optionally set. For example, the way point WP closest to a current position of the mobile object 10 may be set as the way point WP of the movement source. The way point WP of the movement destination may be optionally set. For example, the way point WP of a position corresponding to the movement destination of the mobile object 10 indicated by the movement destination information may be set as the way point WP of the movement destination.

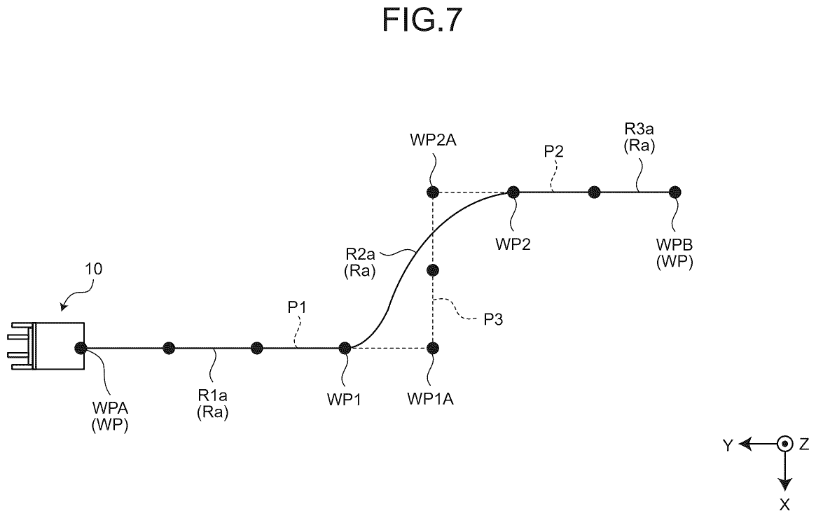

FIG. 6 is a schematic diagram illustrating an example of the way points through which the mobile object is expected to pass. In the following description, exemplified is a case in which the way point setting unit 60 sets the way points WP so that a path connecting the way points WP set by the way point setting unit 60 includes a first path P1, a second path P2 intersecting with the first path P1, and a connection path P3 intersecting with the first path P1 and the second path P2 and connecting the first path and the second path P2. Herein, the path means a line connecting the way points WP set by the way point setting unit 60. The connection path P3 is a path connected to an end part of the first path P1 on the movement destination side of the mobile object 10, and intersects with the first path P1. Moreover, the connection path P3 is also a path connected to an end part of the second path P2 on the movement source side of the mobile object 10, and also intersects with the second path P2. The second path P2 is a path connected to an end part of the connection path P3 on the movement destination side of the mobile object 10, and intersects with the first path P1 and the connection path P3. It should be noted that in the present embodiment, “paths intersect with each other” means that the paths are not continuously connected, and the paths are connected via a bending point with an extreme value. That is, for example, the first path P1 and the second path P2 in this example are parallel routes, but it can be said that the first path P1 intersects with the second path P2 because they are discontinuously connected via the connection path P3. Moreover, the first path and the connection path P3 are connected via a bending point (way point WP1A) with an extreme value, so that it can be said that they intersect with each other. In the present embodiment, the first path P1, the second path P2, and the connection path P3 each have a linear shape, but the embodiment is not limited thereto. They may have a curved shape.

FIG. 6 illustrates an example of the first path P1, the second path P2, and the connection path P3. FIG. 6 exemplifies a case in which a direction from a way point WPA toward a way point WPB is a movement direction of the mobile object 10, and the way points WP through which the mobile object 10 is expected to pass are set to include the first path P1 connecting the way point WPA and a way point WP1, the second path P2 connecting a way point WP2 and the way point WPB, and the connection path P3 connecting the first path P1 and the second path P2. It should be noted that the way point WP1 (first way point) is the way point WP closest to the second path P2 among the way points WP included in the first path P1. The way point WP1A is the way point WP adjacent to the way point WP1 on the movement destination side (second path P2 side), and is a connection point between the first path P1 and the connection path P3 (bending point with an extreme value). Moreover, the way point WP2 (second way point) is the way point WP closest to the first path P1 among the way points WP included in the second path P2. The way point WP2A is the way point WP adjacent to the way point WP2 on the movement source side (second path P2 side), and is a connection point between the second path P2 and the connection path P3 (bending point with an extreme value). It should be noted that in the example of the present embodiment, the way point WP1A and the way point WP2A are not called the way points WP on the connection path P3, but may be called a way point of the connection point (corner portion) between the first path P1 and the connection path P3, and a way point of the connection point (corner portion) between the second path P2 and the connection path P3, respectively. That is, in this example, it can be said that the connection path P3 includes the respective way points from a way point adjacent to the way point WP1A on the movement destination side and a way point adjacent to the way point WP2A on the movement source side.

### (Setting of Route)

The route setting unit 62 of the information processing device 14 sets the route R along which the mobile object 10 moves based on the way points WP set by the way point setting unit 60. In the present embodiment, the route setting unit 62 sets, as the route R, a rout passing through positions within a predetermined distance range with respect to the way points WP set by the way point setting unit 60. More specifically, the route setting unit 62 calculates, by optimization calculation, a route passing through positions within the predetermined distance range with respect to the way points WP set by the way point setting unit 60 while satisfying a constraint condition based on motion characteristics of the mobile object 10 to be the route R. The constraint condition for optimization calculation includes a minimum turning radius of the mobile object 10. More specifically, the constraint condition may include at least one (preferably, all) of the following: passing through the positions within the predetermined distance range with respect to the set way points WP; an upper limit speed of the mobile object 10; and the condition that the mobile object 10 does not enter a prohibition region where entry is prohibited. It should be noted that the predetermined distance herein may be appropriately set.

The following describes an example of a setting method for the route R by optimization calculation. In the following description, exemplified is a setting method for the route R by using a Collocation method (trapezoidal rule). However, the setting method for the route R is not limited thereto, but may be optional.

Here, assuming that an operation variable of the mobile object 10 at a calculation point i is u(i), a state variable of the mobile object 10 at the calculation point i is x(i), and a change amount of the state variable is f, the operation variable, the state variable, and the change amount of the state variable of the mobile object 10 are represented by the following expressions (1) to (3) by way of example. In the expression (1), v(i) is a speed of the mobile object 10, and φ(i) is a steering angle of the mobile object 10. In the expression (2), θ(i) is an azimuth angle (attitude) of the mobile object 10, px(i) and py(i) are an X-coordinate and a Y-coordinate of the mobile object 10, and Δt is a time between calculation points.

$${u}_{( i )} = [ \begin{matrix}{v}_{( i )} \\ {ϕ}_{( i )}\end{matrix} ] \qquad ( 1 )$$

$${x}_{( i )} = [ \begin{matrix}{θ}_{( i )} \\ {px}_{( i )} \\ {py}_{( i )} \\ Δ t\end{matrix} ] \qquad ( 2 )$$

$${x}_{( i + 1 )} - {x}_{( i )} = f ( {x}_{( i )} , {u}_{( i )} ) = [ \begin{matrix}\frac{( {v}_{( i )} tan ( {ϕ}_{( i )} ) + {v}_{( i + 1 )} tan ( {ϕ}_{( i + 1 )} ) )}{2 W} Δ t \\ \frac{{v}_{( i )} cos {θ}_{( i )} + {v}_{( i + 1 )} cos {θ}_{( i + 1 )}}{2} Δ t \\ \frac{{v}_{( i )} sin {θ}_{( i )} + {v}_{( i + 1 )} sin {θ}_{( i + 1 )}}{2} Δ t \\ 0\end{matrix} ] \qquad ( 3 )$$

$$( i = 0 ∼ N - 2 )$$

The route setting unit 62 performs optimization calculation represented by the following expression (4) to calculate the route R, for example. More specifically, the route setting unit 62 performs optimization calculation of the expression (4) to calculate the route R while satisfying constraints of the following expressions (5) and (6). In the expression (4), Nu is the number of control variables, Nx is the number of state variables, N is the number of calculation points, and J is an evaluation function value. Moreover, in the expression (6), H indicates the constraint condition.

$${min}_{\text{?} ∈ {ℝ}^{{N}_{\text{?}} \text{?} N} , X ∈ {ℝ}^{{N}_{\text{?}} \text{?} N}} J \qquad ( 4 )$$

$${x}_{( i + 1 )} = {x}_{( i )} + f ( {x}_{( i )} , {u}_{( i )} ) ∀ i ∈ [ 0 , N ] \qquad ( 5 )$$

$$H ( {x}_{( i + 1 )} , {x}_{( i )} , {u}_{( i )} ) \leq 0 ∀ i ∈ [ 0 , N ] \qquad ( 6 )$$

$$\text{?} \text{indicates text missing or illegible when filed}$$

### (Turning Route)

Here, in a case of setting the route R based on the way points WP including the first path P1, the connection path P3, and the second path P2, a route for turning (turning route) is required to be set at corner portions (discontinuous connection points) corresponding to a position where the first path P1 is switched to the connection path P3 and a position where the connection path P3 is switched to the second path P2. However, in a case of setting such a turning route, it may be impossible to set a route passing through the positions within the predetermined distance range with respect to the way point WP of the corner portion while satisfying the constraint condition such as a minimum turning radius of the mobile object 10. That is, for example, to pass through the position within the predetermined distance range with respect to the way point WP of the corner portion, the turning route may be set only with a smaller turning radius than the minimum turning radius. Thus, in the present embodiment, in such a case, the turning route can be appropriately set by resetting the way points WP as targets for passing through the positions within the predetermined distance range to calculate the route R. The following is specific description.

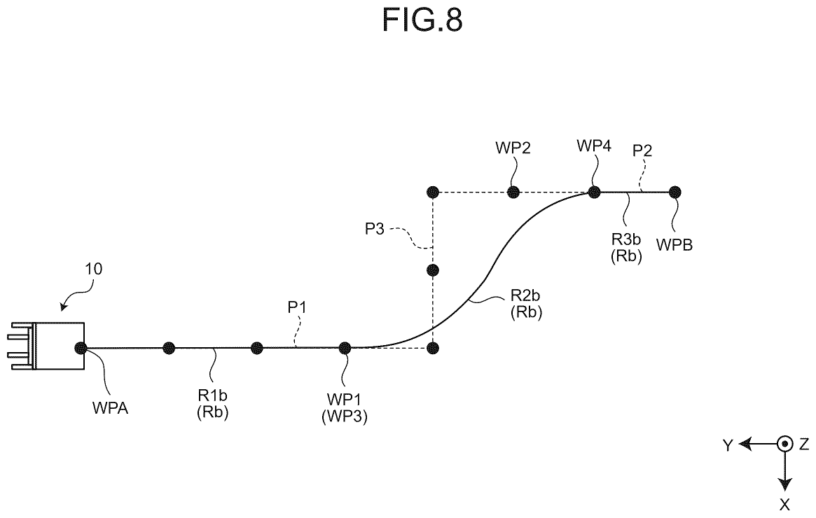

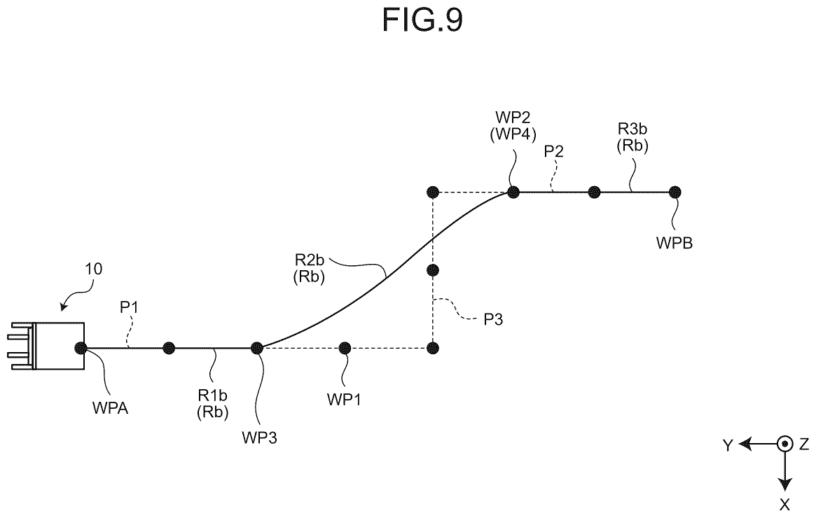

FIG. 7 and FIG. 8 are schematic diagrams illustrating an example of setting of the route for turning. In a case of setting the route R based on the way points WP including the first path P1, the second path P2, and the connection path P3, the route setting unit 62 determines whether a route Ra including a route R2a (first route) can be set. The route R2a is a turning route passing through positions within the predetermined distance range with respect to the way point WP1 (first way point), and positions within the predetermined distance range with respect to the way point WP2 (second way point). Specifically, as illustrated in FIG. 7, the route Ra includes a route R1a corresponding to the first path P1, the route R2a corresponding to the connection path P3, and a route R3a corresponding to the second path P2. The route R1a is a route passing through the respective positions within the predetermined distance range with respect to the respective way points WP from the way point WPA to the way point WP1 included in the first path P1. It should be noted that in the example of FIG. 7, the route R1a passes through the respective way points WP from the way point WPA to the way point WP1, but the embodiment is not limited thereto. The route R1a may be a route passing through positions distant from the way points WP by a predetermined distance, and the same applies to the other routes. Moreover, as described above, the route R2a is a route passing through the positions within the predetermined distance range with respect to the way point WP1 and the positions within the predetermined distance range with respect to the way point WP2. That is, in the present embodiment, in setting the route R2a, a constraint condition of passing through the respective positions within the predetermined distance range with respect to the way point WP1 and the way point WP2 is set without setting a constraint condition of passing through the respective positions within the predetermined distance range with respect to the respective way points WP (the way point WP1A to the way point WP2A) included in the connection path P3. Moreover, the route R3a is a route passing through the respective positions within the predetermined distance range with respect to the respective way points WP from the way point WP2 to the way point WPB included in the second path P2.

In a case in which the route Ra including the route R2a passing through the positions within the predetermined distance range from the way points WP1 and WP2 can be set, the route setting unit 62 sets the route Ra as the route R along which the mobile object 10 moves. On the other hand, in a case in which the route Ra including the route R2a cannot be set, the route setting unit 62 resets the way points WP as targets for passing through the positions within the predetermined distance range, and sets a route Rb including a route R2b as a turning route based on the reset way points WP. The following describes a setting method for the route Rb. It should be noted that a criterion for determining that the route Ra cannot be set is optional. For example, it may be determined that the route Ra cannot be set in a case in which it is impossible to calculate the optimized route R2a passing through the respective positions within the predetermined distance range with respect to the way point WP1 and the way point WP2 (second way point) while satisfying other constraint conditions.

In a case in which the route Ra cannot be set, as illustrated in FIG. 8, the route setting unit 62 sets a way point WP4 (fourth way point) at a position more distant from the first path P1 than the way point WP2 (position on the movement destination side). The route setting unit 62 then sets the route Rb including the route R2b based on the way point WP4. The route R2b is a turning route passing through the positions within the predetermined distance range with respect to the way point WP1 and the positions within the predetermined distance range with respect to the way point WP4. Specifically, as illustrated in FIG. 8, the route Rb is a route including a route R1b corresponding to the first path P1, the route R2b corresponding to the connection path P3, and a route R3b corresponding to the second path P2. The route R1b is a route passing through the respective positions within the predetermined distance range with respect to the respective way points WP from the way point WPA to the way point WP1. Moreover, as described above, the route R2b is a route passing through the positions within the predetermined distance range with respect to the way point WP1 and the positions within the predetermined distance range with respect to the way point WP4. That is, in the present embodiment, in setting the route R2b, a constraint condition of passing through the respective positions within the predetermined distance range with respect to the way point WP1 and the way point WP4 is set. Moreover, the route R3b is a route passing through the respective positions within the predetermined distance range with respect to the respective way points WP from the way point WP4 to the way point WPB.

The route setting unit 62 sets the route Rb including the set route R2b to be the route R along which the mobile object 10 moves. In this way, in the present embodiment, the route R2b is tried to be set with a constraint condition of passing through the way points WP1 and WP4 in a case in which the route R2a as a turning route passing through the way points WP1 and WP2 cannot be set. Due to this, a distance from a starting point to an ending point of the turning route can be increased, and the turning route satisfying the constraint condition can be easily set, so that the turning route can be appropriately set.

It should be noted that in the description of FIG. 8, the route R2b is set with the constraint condition of passing through the way points WP1 and WP4, but the embodiment is not limited thereto. The route R2b may be a route in which a distance from the way point WP as a starting point to the way point WP as an ending point is longer than a distance from the way point WP1 as a starting point to the way point WP2 as an ending point of the route R2a. The following describes other examples of the route R2b.

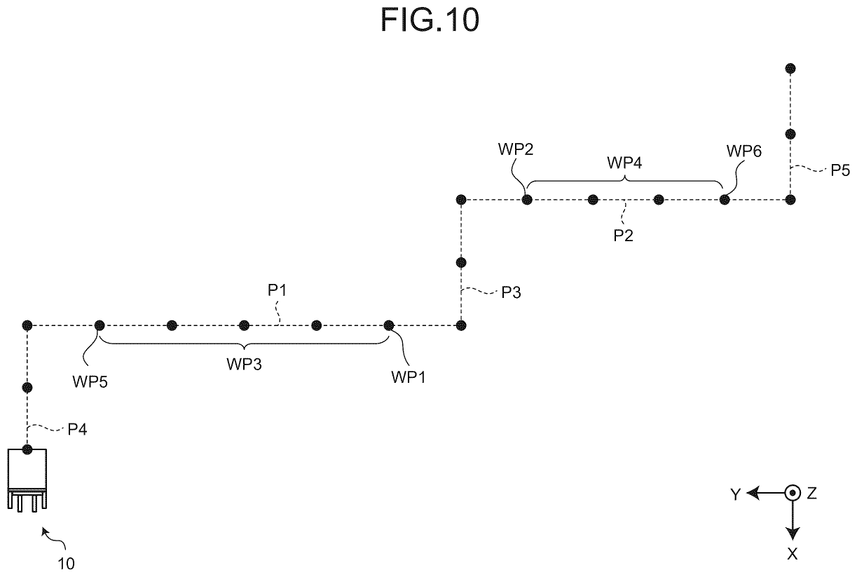

FIG. 9 is a schematic diagram illustrating another example of setting of the route for turning. In a case in which the route Ra cannot be set, as illustrated in FIG. 9, the route setting unit 62 may set a way point WP3 (third way point) at a position more distant from the second path P2 than the way point WP1 (position on the movement source side). The route setting unit 62 may then set the route Rb including the route R2b based on the way point WP3. In this case, the route R2b is a turning route passing through the positions within the predetermined distance range with respect to the way point WP3 and the positions within the predetermined distance range with respect to the way point WP2. Specifically, as illustrated in FIG. 9, the route Rb is a route including the route R1b corresponding to the first path P1, the route R2b corresponding to the connection path P3, and the route R3b corresponding to the second path P2. The route R1b is a route passing through the respective positions within the predetermined distance range with respect to the respective way points WP from the way point WPA to the way point WP3. Moreover, as described above, the route R2b is a route passing through the positions within the predetermined distance range with respect to the way point WP3 and the positions within the predetermined distance range with respect to the way point WP2. That is, in this example, in setting the route R2b, a constraint condition of passing through the respective positions within the predetermined distance range with respect to the way point WP3 and the way point WP2 is set. Moreover, the route R3b is a route passing through the respective positions within the predetermined distance range with respect to the respective way points WP from the way point WP2 to the way point WPB. As in the example of FIG. 9, by trying to set the route R2b with the constraint condition of passing through the way points WP3 and WP2, the distance from the starting point to the ending point of the turning route can be increased, and the turning route can be appropriately set.

Moreover, for example, in a case in which the route Ra cannot be set, the route setting unit 62 may set the route R2b to pass through the respective positions within the predetermined distance range with respect to the way point WP3 at a position more distant from the second path P2 than the way point WP1 and the way point WP4 at a position more distant from the first path P1 than the way point WP2.

That is, in summary, in a case in which the route Ra cannot be set, the route setting unit 62 sets the same position as the way point WP1 or a position more distant from the second path P2 than the way point WP1 as the third way point (herein, the way point WP1 or the way point WP3), and sets the same position as the way point WP2 or a position more distant from the first path P1 than the way point WP2 as the fourth way point (herein, the way point WP2 or the way point WP4). It can be said that the route setting unit 62 then sets, as the route R for the mobile object, the route Rb including the route R2b passing through the positions within the predetermined distance from the third way point and the positions within the predetermined distance from the fourth way point. However, in this case, the third way point and the fourth way point are set at positions with which a distance from the third way point to the fourth way point is longer than a distance from the way point WP1 to the way point WP2.

It should be noted that in a case in which the route R2b passing through the positions within the predetermined distance from the third way point and the positions within the predetermined distance from the fourth way point cannot be set, the route setting unit 62 may reset at least one of the third way point and the fourth way point to be more distant from the second path P2, and may try to reset the route R2b. That is, in a case in which the route R2b cannot be set with the constraint condition of passing through the third way point and the fourth way point, at least one of the third way point and the fourth way point may be reset, and the route R2b may be set with a constraint condition of passing through the reset third way point and fourth way point. For example, in the example of FIG. 8, in a case in which the route R2b passing through the way points WP1 and WP4 cannot be set, the route setting unit 62 resets the way point WP4 at a position more distant from the first path P1 than the original way point WP4, and resets a route passing through the way point WP1 and the reset way point WP4 as the route R2b. For example, in the example of FIG. 9, in a case in which the route R2b passing through the way points WP3 and WP2 cannot be set, the route setting unit 62 resets the way point WP3 at a position more distant from the second path P2 than the original way point WP3, and sets a route passing through the reset way point WP3 and way point WP2 as the route R2b.

The route setting unit 62 may repeat the processing of resetting at least one of the third way point and the fourth way point until the route R2b can be set. In a case in which the route R2b cannot be set even if the processing of resetting at least one of the third way point and the fourth way point is repeated a predetermined number of times, the way point setting unit 60 may reset the way points WP through which the mobile object 10 is expected to pass. That is, in this case, the way point setting unit 60 resets the respective way points WP connecting the way point WP of the movement source and the way point WP of the movement destination to pass through another path, and sets these way points WP to be the way points WP through which the mobile object 10 is expected to pass. In this case, the route setting unit 62 sets the route R based on the reset way points WP.

### (Setting Example of Way Points WP3 and WP4)

The way point WP3 and the way point WP4 used for setting the route R2b may be set at optional positions more distant from the second path P2 than the way point WP1 or the way point WP4. For example, the route setting unit 62 may set, as the way point WP3 (third way point), a position on the first path P1 distant from the way point WP1 by a predetermined distance toward a side away from the second path P2. Moreover, in a case in which the route R2b cannot be set by using the set way point WP3, a position on the first path P1 distant from the set way point WP3 by a predetermined distance toward a side away from the second path P2 may be reset as the way point WP3. That is, the way point WP3 may be updated to be away from the second path P2 by an equal distance each time until the route R2b can be set. Moreover, for example, the route setting unit 62 may set, as the way point WP4 (fourth way point), a position on the second path P2 distant from the way point WP2 by a predetermined distance toward a side away from the first path P1. Moreover, in a case in which the route R2b cannot be set by using the set way point WP4, a position on the second path P2 distant from the set way point WP4 by a predetermined distance toward a side away from the first path P1 may be reset as the way point WP4. That is, the way point WP4 may be updated to be away from the first path P1 by an equal distance each time until the route R2b can be set.

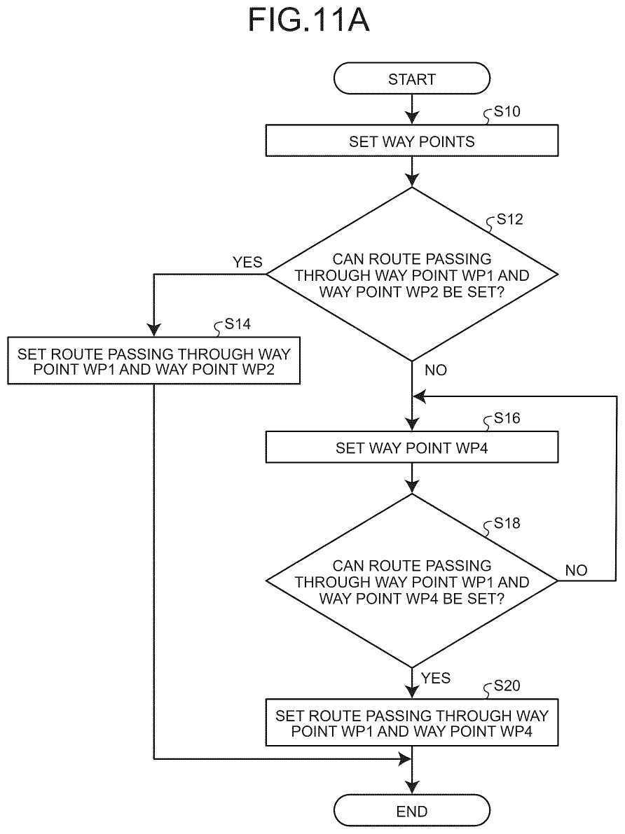

Moreover, for example, the route setting unit 62 may set the way point WP3 or the way point WP4 using binary search. FIG. 10 is a schematic diagram for explaining an example of a setting method for the way points.

Based on FIG. 10, the following describes an example of the method for setting the way point WP3 by binary search. As illustrated in FIG. 10, in this example, the way point setting unit 60 sets the way points WP through which the mobile object 10 is expected to move to also include a fourth path P4. The fourth path P4 is a path that is connected to an end part of the first path P1 on the movement source side and intersects with the first path P1. Moreover, among the way points WP included in the first path P1, the way point WP closest to the fourth path P4 is assumed to be a way point WP5 (fifth way point). In this case, the route setting unit 62 sets the way point WP3 by binary search using the way point WP1 and the way point WP5. That is, the route setting unit 62 first tries to set the route R2b assuming that a center position (first center position) between the way point WP1 and the way point WP5 on the first path P1 is the way point WP3. In a case in which the route R2b can be set assuming that the first center position is the way point WP3, the route setting unit 62 tries to set the route R2b assuming that a center position (second center position) between the first center position and the way point WP1 on the first path P1 is a new way point WP3. On the other hand, in a case in which the route R2b cannot be set assuming that the first center position is the way point WP3, the route setting unit 62 tries to set the route R2b assuming that a center position (third center position) between the first center position and the way point WP5 on the first path P1 is the way point WP3. That is, by repeating binary search processing of resetting the way point WP3 to the way point WP1 side in a case in which the route R2b can be set, and resetting the way point WP3 to the way point WP5 side in a case in which the route R2b cannot be set, a final way point WP3 is set.

Based on FIG. 10, the following describes an example of the method for setting the way point WP4 by binary search. As illustrated in FIG. 10, in this example, the way point setting unit 60 sets the way points WP through which the mobile object 10 is expected to move to also include a fifth path P5. The fifth path P5 is a path that is connected to an end part of the second path P2 on the movement destination side and intersects with the second path P2. Moreover, among the way points WP included in the second path P2, the way point WP closest to the fifth path P5 is assumed to be a way point WP6 (sixth way point). In this case, the route setting unit 62 sets the way point WP4 by binary search using the way point WP2 and the way point WP6. That is, the route setting unit 62 first tries to set the route R2b assuming that a center position (first center position) between the way point WP2 and the way point WP6 on the second path P2 is the way point WP4. In a case in which the route R2b can be set assuming that the first center position is the way point WP4, the route setting unit 62 tries to set the route R2b assuming that a center position (second center position) between the first center position and the way point WP2 on the second path P2 is a new way point WP4. On the other hand, in a case in which the route R2b cannot be set assuming that the first center position is the way point WP4, the route setting unit 62 tries to set the route R2b assuming that a center position (third center position) between the first center position and the way point WP6 on the second path P2 is the way point WP4. That is, by repeating binary search processing of resetting the way point WP4 to the way point WP2 side in a case in which the route R2b can be set, and resetting the way point WP4 to the way point WP6 side in a case in which the route R2b cannot be set, a final way point WP4 is set.

### (Acquisition of Route)

The route R for the mobile object 10 is set as follows. The control device 28 of the mobile object 10 acquires information about the route R by the route acquisition unit 80.

### (Movement of Mobile Object)

The control device 28 of the mobile object 10 causes the movement control unit 84 to move the mobile object 10 along the acquired route R. In this case, by successively grasping position information of the mobile object 10 (for example, the position and the attitude of the mobile object 10) by the self-position acquisition unit 82, the control device 28 causes the mobile object 10 to move to pass through the route R. An acquisition method for the position information of the mobile object 10 is optional. For example, in the present embodiment, a detection body (not illustrated) is disposed in the facility W, and the self-position acquisition unit 82 acquires information about the position and the attitude of the mobile object 10 based on detection of the detection body. Specifically, the mobile object 10 emits laser light toward the detection body, and receives reflected light of the laser light from the detection body to detect the position and the attitude of itself in the facility W. The acquisition method for the position and the attitude of the mobile object 10 is not limited to using the detection body. For example, Simultaneous Localization And Mapping (SLAM) may be used.

### (Control Flow)

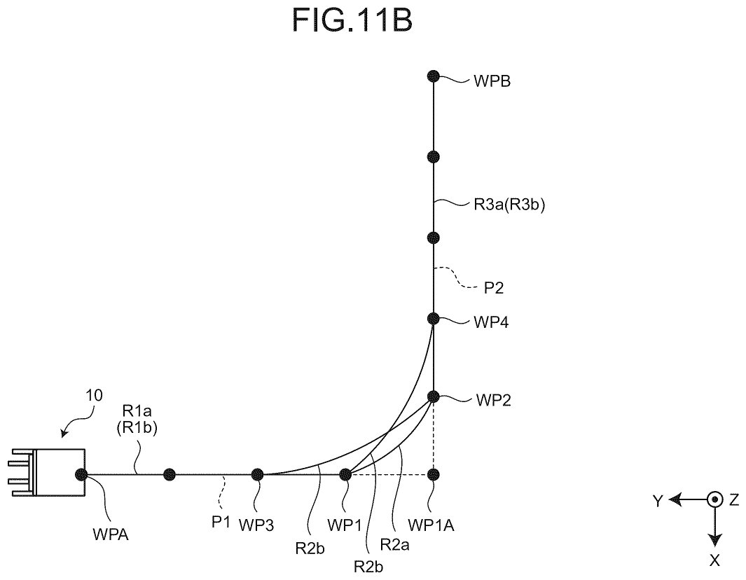

The following describes a processing flow of setting of the route R described above. FIG. 11A is a flowchart for explaining the processing flow of setting of the route according to the present embodiment. As illustrated in FIG. 11A, the information processing device 14 sets the way points WP through which the mobile object 10 is expected to pass by the way point setting unit 60 (Step S10), and tries to set the route R2a passing through the positions within the predetermined distance range from the way point WP1 and the way point WP2 by the route setting unit 62 (Step S12). If the route R2a can be set (Yes at Step S12), the route Ra including the route R2a is set as the route R along which the mobile object 10 moves (Step S14). On the other hand, if the route R2a cannot be set (No at Step S12), the route setting unit 62 sets the way point WP4 (Step S16), and tries to set the route R2b passing through the positions within the predetermined distance range from the way point WP1 and the way point WP4 (Step S18). If the route R2b cannot be set (No at Step S18), the process returns to Step S16, the way point WP4 is reset, and the succeeding processing is repeated. If the route R2b can be set (Yes at Step S18), the route Rb including the route R2b is set as the route R along which the mobile object 10 moves (Step S20). It should be noted that in the description of this processing flow, the route R2b passing through the positions within the predetermined distance range from the way point WP1 and the way point WP4 is set, but the route R2b passing through the third way point and the fourth way point may be set as described above.

### OTHER EXAMPLES

In the above description, described is the setting method for the route in a case in which the first path P1 and the second path P2 are connected via the connection path P3, but the route R can be set by using the same method even when the first path P1 and the second path P2 are directly connected without the connection path P3. The following is specific description.

FIG. 11B is a schematic diagram illustrating another example of setting of the route for turning. As illustrated in FIG. 11B, in this example, the first path P1 and the second path P2 are connected to intersect with each other via the way point WP1A. Also in this case, the route setting unit 62 determines whether to be able to set the route R2a as a turning route passing through the positions within the predetermined distance range with respect to the way point WP1 and the positions within the predetermined distance range with respect to the way point WP2. In a case in which the route R2a cannot be set, the route setting unit 62 sets the same position as the way point WP1 or a position more distant from the second path P2 than the way point WP1 as the third way point (herein, the way point WP1 or the way point WP3), and sets the same position as the way point WP2 or a position more distant from the first path P1 than the way point WP2 as the fourth way point (herein, the way point WP2 or the way point WP4). It can be said that the route setting unit 62 then sets, as the route R for the mobile object, the route Rb including the route R2b passing through the positions within the predetermined distance from the third way point and the positions within the predetermined distance from the fourth way point.

As described above, in the present embodiment, in a case of setting the route R based on the way points WP including the first path P1 and the second path P2, if the route R2a passing through the positions within the predetermined distance range from the way point WP1 and the way point WP2 cannot be set, the more distant third way point and fourth way point are set. The route R2b passing through the positions within the predetermined distance range from the third way point and the fourth way point is then set, and the route Rb including the route R2b is set as the route R for the mobile object 10. Thus, according to the present embodiment, the distance from the starting point to the ending point of the turning route can be increased, and the turning route satisfying the constraint condition can be easily set, so that the route R including the turning route can be appropriately set.

It should be noted that in the present embodiment, the information processing device 14 sets the way points WP through which the mobile object 10 is expected to pass and the route R by the way point setting unit 60 and the route setting unit 62. However, a subject that sets the way points WP and the route R is not limited to the information processing device 14, but may be optional. For example, the mobile object 10 may include the way point setting unit 60 to set the way points WP through which the mobile object 10 is expected to pass. Moreover, for example, the mobile object 10 may include the route setting unit 62 to set the route R based on the set way points WP.

### Second Embodiment

Next, the following describes a second embodiment. The second embodiment is different from the first embodiment in that a prohibition region is set based on a route RB that is set for another mobile object, and the route R for the mobile object 10 is set not to pass through the prohibition region. In the second embodiment, description about the same configurations as those in the first embodiment will not be repeated.

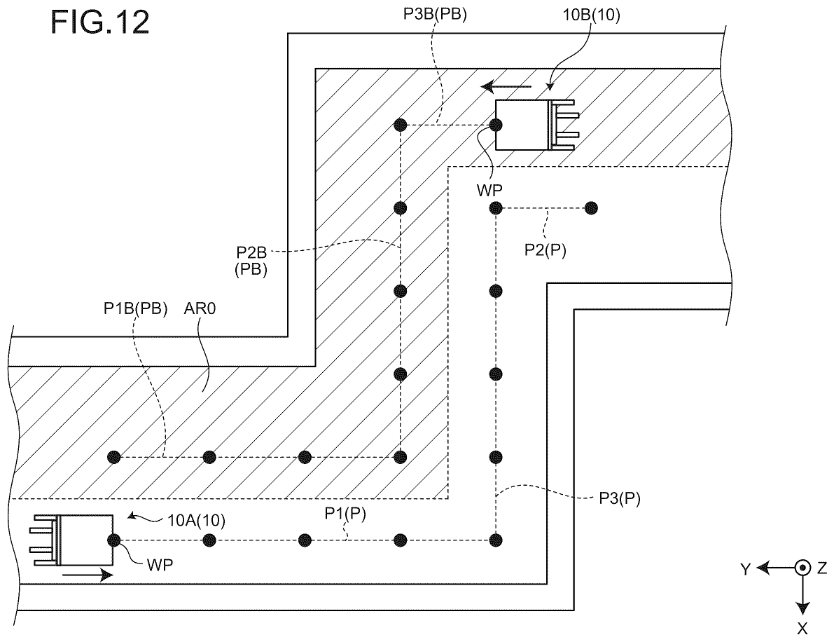

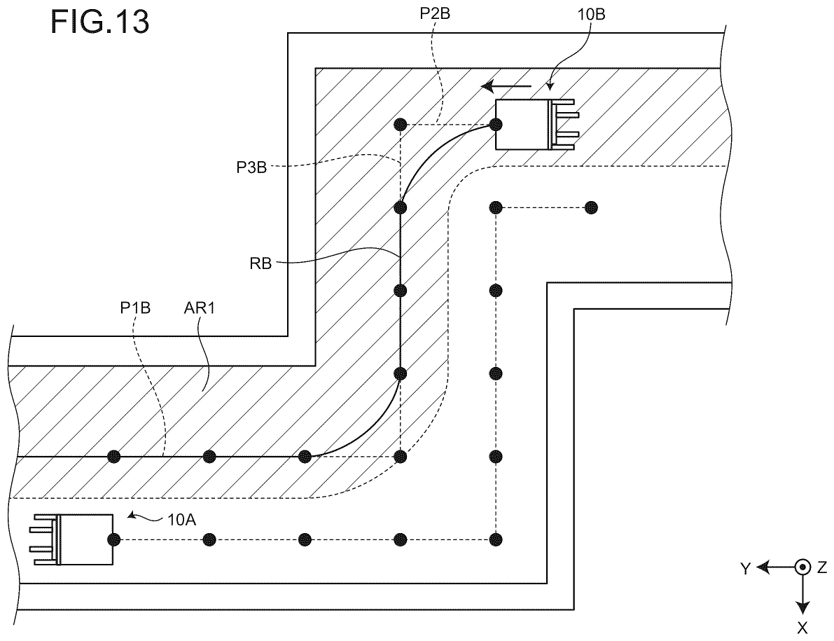

FIG. 12 and FIG. 13 are schematic diagrams for explaining setting of the prohibition region. In the second embodiment, the mobile object 10 for which the route R is set is assumed to be a mobile object 10A, and the mobile object 10 other than the mobile object 10A is assumed to be a mobile object 10B. Moreover, in the second embodiment, as illustrated in FIG. 12, exemplified is a case in which a path PB connecting the way points WP through which the mobile object 10B is expected to pass (in the example of FIG. 12, a path including a path P1B adjacent to the first path P1, a path P2B adjacent to the second path P2, and a path P3B adjacent to the connection path P3) is set to be adjacent to a path P connecting the way points WP through which the mobile object 10A is expected to pass (in the example of FIG. 12, a path including the first path P1, the second path P2, and the connection path P3), and a time period in which the mobile object 10B passes through the route RB corresponding to the path PB overlaps a time period in which the mobile object 10A passes through the route R corresponding to the path P. That is, the following exemplifies a case in which the mobile object 10A and the mobile object 10B move on adjacent lanes (in this example, opposite lanes) in the same time period.

In a case in which the path PB for the mobile object 10B is set as described above, in setting the route R for the mobile object 10A, a region AR0 within a predetermined distance range from the path PB can be also set as the prohibition region that prohibits entry of the mobile object 10A. However, as illustrated in FIG. 13, the mobile object 10B does not actually pass through the path PB, but passes through the route RB that is set based on the way points WP included in the path PB using the same method as that for the route R for the mobile object 10A. Thus, in the present embodiment, the route setting unit 62 sets the prohibition region based on the route RB through which the mobile object 10B actually pass instead of the path PB for the mobile object 10B. Specifically, in the present embodiment, the route setting unit 62 acquires information about the route RB for the mobile object 10B that has been set earlier than the route R for the mobile object 10A. The route setting unit 62 then sets a region AR1 within a predetermined distance range from the route RB as the prohibition region that prohibits entry of the mobile object 10A. Due to this, the prohibition region reflecting an actual moving route of the mobile object 10B can be set, so that the route R for the mobile object 10A can be set more appropriately. Particularly, a turning route included in the route RB for the mobile object 10B (a route corresponding to a boundary position between the path P2B and the path P1B) runs on an inner side than the path PB, so that the region AR1 (prohibition region) within the predetermined distance range from the route RB is smaller than the region AR1 within the predetermined distance range from the route RB. Accordingly, the actual moving route of the mobile object 10B can be reflected, and the prohibition region can be prevented from being excessively large, so that the route R for the mobile object 10A can be set more appropriately.

### EFFECTS OF PRESENT DISCLOSURE

The route setting method according to a first aspect of the present disclosure includes a step of acquiring information about the way points WP through which the mobile object 10 is expected to pass, and a step of setting the route R for the mobile object 10 based on the way points WP. At the step of setting the route R, the path P connecting the way points WP includes the first path P1 and the second path P2 intersecting with the first path P1. Assuming that the way point WP closest to the second path P2 on the first path P1 is the first way point (way point WP1) and the way point WP closest to the first path P1 on the second path P2 is the second way point (way point WP2), in a case in which the first route (route R2a) passing through the positions within the predetermined distance from the first way point and the positions within the predetermined distance from the second way point cannot be set, the third way point (the way point WP1 or the way point WP3) at the same position as the first way point or a position more distant from the second path P2 than the first way point and the fourth way point (the way point WP2 or the way point WP4) at the same position as the second way point or a position more distant from the second path P2 than the second way point are set so that the distance from the third way point to the fourth way point is longer than the distance from the first way point to the second way point. The route R2b passing through the positions within the predetermined distance from the third way point and the positions within the predetermined distance from the fourth way point is then set as the route for the mobile object 10. According to this method, in a case in which the turning route passing through the first way point and the second way point cannot be set, the distance from the starting point to the ending point of the turning route can be increased, and the turning route satisfying the constraint condition can be easily set, so that the route R including the turning route can be appropriately set.

The route setting method according to a second aspect of the present disclosure is the route setting method according to the first aspect in which the route R is set to satisfy the constraint condition based on motion characteristics of the mobile object 10 at the step of setting the route R, and it is determined that the first route cannot be set in a case in which the first route (route R2b) satisfying the constraint condition cannot be set. According to the present disclosure, in a case in which the first route cannot be set, the route R including the turning route can be appropriately set by increasing the distance from the starting point to the ending point of the turning route.

The route setting method according to a third aspect of the present disclosure is the route setting method according to the first aspect or the second aspect in which, at the step of setting the route R, in a case of setting the third way point (way point WP3) at a position more distant from the second path P2 than the first way point (way point WP1), the position on the first path P1 distant from the first way point by the predetermined distance toward a side away from the second path P2 is set as the third way point. Moreover, in a case of setting the fourth way point (way point WP4) at the position more distant from the first path P1 than the second way point (way point WP2), the position on the second path P2 distant from the second way point by the predetermined distance toward a side away from the first path P1 is set as the fourth way point. By setting the third way point and the fourth way point as described above, the distance from the starting point to the ending point of the turning route can be appropriately increased, and the route R including the turning route can be appropriately set.

The route setting method according to a fourth aspect of the present disclosure is the route setting method according to the first aspect or the second aspect in which, at the step of setting the route R, in a case of setting the third way point (way point WP3) at a position more distant from the second path P2 than the first way point (way point WP1), the third way point is set by binary search using the first way point and the fifth way point (way point WP5) on the first path P1 closest to the fourth path intersecting with the first path P1 on the opposite side of the second path P2. Moreover, in a case of setting the fourth way point (way point WP4) at the position more distant from the first path P1 than the second way point (way point WP2), the fourth way point is set by binary search using the second way point and the sixth way point (way point WP6) on the second path P2 closest to the fifth path P5 intersecting with the second path P2 on the opposite side of the first path P1. By setting the third way point and the fourth way point as described above, the distance from the starting point to the ending point of the turning route can be appropriately increased, and the route R including the turning route can be appropriately set.

The route setting method according to a fifth aspect of the present disclosure is the route setting method according to any one of the first aspect to the fourth aspect in which, when the path P further includes the connection path P3 intersecting with the first path P1 and the second path P2 and connecting the first path P1 and the second path P2, the route R for the mobile object 10 is set without setting the constraint condition of passing through the positions within the predetermined distance range with respect to the respective way points WP included in the connection path P3 at the step of setting the route R. Accordingly, the turning route in a case of including a plurality of corner portions can be appropriately set.

The route setting method according to a sixth aspect of the present disclosure is the route setting method according to any one of the first aspect to the fifth aspect further including the step of acquiring information about the other route (route RB) as a route set for the other mobile object (mobile object 10B) different from the mobile object 10A for which the route R is set. At the step of setting the route R, the region AR1 within the predetermined distance range from the other route is set as the prohibition region, and the route R is set so that the mobile object 10 does not pass through the prohibition region. According to the present disclosure, the prohibition region reflecting the actual moving route of the mobile object 10B can be set, so that the route R for the mobile object 10A can be set more appropriately.

The route setting method according to a seventh aspect of the present disclosure is the route setting method according to the sixth aspect in which, at the step of setting the route R, the prohibition region is set to be smaller than the region AR0 within the predetermined distance range from the path PB adjacent to the first path P1 and the second path P2 set for the other mobile object (mobile object 10B). According to the present disclosure, the actual moving route of the mobile object 10B can be reflected, and the prohibition region can be prevented from being excessively large, so that the route R for the mobile object 10A can be set more appropriately.

A computer program according to an eighth aspect of the present disclosure causes a computer to perform the step of acquiring the information about the way points WP through which the mobile object 10 is expected to pass, and the step of setting the route R for the mobile object 10 based on the way points WP. At the step of setting the route R, the path P connecting the way points WP includes the first path P1 and the second path P2 intersecting with the first path P1. Assuming that the way point WP closest to the second path P2 on the first path P1 is the first way point (way point WP1) and the way point WP closest to the first path P1 on the second path P2 is the second way point (way point WP2), in a case in which the first route (route R2a) passing through the positions within the predetermined distance from the first way point and the positions within the predetermined distance from the second way point cannot be set, the third way point (the way point WP1 or the way point WP3) at the same position as the first way point or a position more distant from the second path P2 than the first way point and the fourth way point (the way point WP2 or the way point WP4) at the same position as the second way point or a position more distant from the second path P2 than the second way point are set so that the distance from the third way point to the fourth way point is longer than the distance from the first way point to the second way point. The route R2b passing through the positions within the predetermined distance from the third way point and the positions within the predetermined distance from the fourth way point is then set as the route for the mobile object 10. With this computer program, the route R including the turning route can be appropriately set.

The mobile object 10 according to a ninth aspect of the present disclosure moves along the route R that is set based on the information about the way points WP through which the mobile object 10 is expected to pass. In a case in which the path P connecting the way points WP includes the first path P1 and the second path P2 intersecting with the first path P1, and the way point WP closest to the second path P2 on the first path P1 is assumed to be the first way point (way point WP1) and the way point WP closest to the first path P1 on the second path P2 is assumed to be the second way point (way point WP2), when the first route (route R2a) passing through the positions within the predetermined distance from the first way point and the positions within the predetermined distance from the second way point cannot be set, the route R is set to pass through the positions within the predetermined distance from the third way point and the positions within the predetermined distance from the fourth way point. The third way point is present at the same position as the first way point or a position more distant from the second path P2 than the first way point, the fourth way point is present at the same position as the second way point or a position more distant from the second path P2 than the second way point, and the distance from the third way point to the fourth way point is longer than the distance from the first way point to the second way point. According to the present disclosure, the mobile object 10 can be caused to move along the route R including the turning route that is appropriately set.

The embodiments of the present disclosure have been described above, but the embodiments are not limited thereto. The constituent elements described above encompass a constituent element easily conceivable by those skilled in the art, substantially the same constituent element, and what is called an equivalent. Additionally, the constituent elements described above can be appropriately combined with each other. Furthermore, the constituent elements can be variously omitted, replaced, or modified without departing from the gist of the embodiments described above.

### REFERENCE SIGNS LIST

10 MOBILE OBJECT
12 MANAGEMENT DEVICE
14 INFORMATION PROCESSING DEVICE
60 WAY POINT SETTING UNIT
62 ROUTE SETTING UNIT
R, Ra, Rb ROUTE
WP, WP1, WP2, WP3, WP4 WAY POINT

1. A route setting method comprising:
a step of acquiring information about way points through which a mobile object is expected to pass; and
a step of setting a route for the mobile object based on the way points, wherein,
at the step of setting the route,
in a case in which a path connecting the way points includes a first path and a second path intersecting with the first path, and the way point closest to the second path on the first path is assumed to be a first way point and the way point closest to the first path on the second path is assumed to be a second way point, when a first route from a position within a predetermined distance from the first way point to a position within the predetermined distance from the second way point is unable to be set,
a third way point at the same position as the first way point or a position more distant from the second path than the first way point and a fourth way point at the same position as the second way point or a position more distant from the first path than the second way point are set so that a distance from the third way point to the fourth way point is longer than a distance from the first way point to the second way point, and
a route from a position within the predetermined distance from the third way point to a position within the predetermined distance from the fourth way point is set as the route for the mobile object.

2. The route setting method according to claim 1, wherein, at the step of setting the route, the route is set to satisfy a constraint condition based on motion characteristics of the mobile object, and it is determined that the first route is unable to be set in a case in which the first route satisfying the constraint condition is unable to be set.

3. The route setting method according to claim 1, wherein,
at the step of setting the route,
in a case of setting the third way point at a position more distant from the second path than the first way point, a position on the first path distant from the first way point by a predetermined distance toward a side away from the second path is set as the third way point, and
in a case of setting the fourth way point at a position more distant from the first path than the second way point, a position on the second path distant from the second way point by a predetermined distance toward a side away from the second path is set as the fourth way point.

4. The route setting method according to claim 1, wherein,
at the step of setting the route,
in a case of setting the third way point at a position more distant from the second path than the first way point, the third way point is set by binary search using the first way point and a fifth way point on the first path closest to a fourth path intersecting with the first path on an opposite side of the second path, and
in a case of setting the fourth way point at a position more distant from the first path than the second way point, the fourth way point is set by binary search using the second way point and a sixth way point on the second path closest to a fifth path intersecting with the second path on an opposite side of the first path.

5. The route setting method according to claim 1, wherein,
in a case in which the path further includes a connection path intersecting with the first path and the second path and connecting the first path and the second path,
at the step of setting the route, the route for the mobile object is set without setting a constraint condition of passing through respective positions within a predetermined distance range with respect to respective way points included in the connection path.

6. The route setting method according to claim 1, further comprising:
a step of acquiring information about another route that is a route set for another mobile object different from the mobile object for which the route is set, wherein,
at the step of setting the route, a region within a predetermined distance range from the other route is set as a prohibition region, and the route is set so that the mobile object does not pass through the prohibition region.

7. The route setting method according to claim 6, wherein, at the step of setting the route, the prohibition region is set to be smaller than a region within a predetermined distance range from a path adjacent to the first path and the second path set for the other mobile object.

8. A computer program that causes a computer to execute:
a step of acquiring information about way points through which a mobile object is expected to pass; and
a step of setting a route for the mobile object based on the way points, wherein,
at the step of setting the route for the mobile object,
in a case in which a path connecting the way points includes a first path and a second path intersecting with the first path, and the way point closest to the second path on the first path is assumed to be a first way point and the way point closest to the first path on the second path is assumed to be a second way point, when a first route from a position within a predetermined distance from the first way point to a position within the predetermined distance from the second way point is unable to be set,
a third way point at the same position as the first way point or a position more distant from the second path than the first way point and a fourth way point at the same position as the second way point or a position more distant from the first path than the second way point are set so that a distance from the third way point to the fourth way point is longer than a distance from the first way point to the second way point, and
a route from a position within the predetermined distance from the third way point to a position within the predetermined distance from the fourth way point is set as the route for the mobile object.

9. A mobile object configured to move along a route that is set based on information about way points through which the mobile object is expected to pass, wherein
in a case in which a path connecting the way points include a first path and a second path intersecting with the first path, and the way point closest to the second path on the first path is assumed to be a first way point and the way point closest to the first path on the second path is assumed to be a second way point, when a first route from a position within a predetermined distance from the first way point to a position within the predetermined distance from the second way point is unable to be set,
the route is set from a position within a predetermined distance from a third way point to a position within a predetermined distance from a fourth way point, and
the third way point is present at the same position as the first way point or a position more distant from the second path than the first way point, the fourth way point is present at the same position as the second way point or a position more distant from the first path than the second way point, and a distance from the third way point to the fourth way point is longer than a distance from the first way point to the second way point.
